(19) United States
(12) Patent Application Publication
(10) Pub. No.: US 2006/0133235 A1
(43) Pub. Date: Jun. 22, 2006

(54) Optical disc apparatus

(75) Inventors: Takashi Yasuda, Osaka (JP); Yutaka Kamimori, Osaka (JP)

Correspondence Address: MORGAN LEWIS & BOCKIUS LLP, 1111 PENNSYLVANIA AVENUE NW, WASHINGTON, DC, 20004, US

(73) Assignee: FUNAI ELECTRIC CO., LTD.

(21) Appl. No.: 11/312,632

(22) Filed: Dec. 21, 2005

(30) Foreign Application Priority Data
Dec. 21, 2004 (JP) P.2004-370123

(51) Int. Cl. G11B 7/00

(52) U.S. Cl. 369/44.37; 369/112.01

(57) ABSTRACT

An optical disc apparatus includes: a pickup head including light sources for irradiating laser beams onto each of the two types of optical discs set in the unit main body and photodetectors for detecting the reflected light amount from the optical disc; and a control unit for permitting one light source of the pickup head to irradiate light source and inhibiting the other light source of the pickup head from irradiating light source in accordance with the type of an optical disc set in the unit main body, wherein the pickup head has a monitoring photodetector for detecting the light amount of laser beams irradiated from the each light source and a monitoring output selector for selectively inputting the output of the monitoring photodetector to the control unit.

### BACKGROUND OF THE INVENTION

1. Field of the Invention

The present invention relates to an optical disc apparatus capable of reading/recording data from/onto two types of optical discs.

2. Description of the Related Art

Optical disc apparatuses are generally in widespread use that are capable of reading recorded data and recording data from/onto optical discs such as CDs, DVDs and BDs. Recently, optical disc apparatuses supporting data reading/recording from/onto two types of optical discs are in practical use. For example, an optical disc apparatus capable of recording data onto a CD and a DVD is described in JP-A-2003-99969. Concerning BDs that are expected to be developed and put on the market, optical disc apparatuses supporting data reading/recording from/onto two types of optical discs are expected to be commercialized such as a combination of a CD and a BD as well as a combination of a DVD and a BD.

Wavelength of a laser beam irradiated onto an optical disc in reading/recording data differs depending on the type of an optical disc. Thus, an optical disc apparatus capable of reading/recording data from/onto two types of optical discs includes, on its pickup head, a light source (laser diode) for irradiating laser beams and a photodetector for detecting reflected light from an optical disc for each type of optical discs. The pickup head of an optical disc apparatus is designed to split a laser beam emitted from a light source in order to manage the power of the laser beam irradiated from the light source and detect one split laser beam with a monitoring photodetector. The other split laser beam is irradiated onto an optical disc. An optical disc apparatus supporting data reading/recording from/onto two types of optical discs includes a monitoring photodetector for each light source.

An optical disc apparatus supporting data reading/recording from/onto two types of optical discs includes a control board for specifying a light source to emit laser beams and instructing the light amount of the light source based on the output of the monitoring photodetector to a pickup head in accordance with the type of an optical disc set in the unit main body of the optical disc apparatus. For example, An optical disc apparatus supporting data reading/recording from/onto two types of optical discs, namely CDs and DVDs, includes a control board that gives an optical pickup an instruction to permit a light source for CDs to irradiate laser beams and gives the optical pickup an instruction to inhibit a light source for DVDs from irradiating laser beams when a CD is set in the unit main body, and gives the optical pickup an instruction to inhibit the light source for CDs from irradiating laser beams and gives the optical pickup an instruction to permit the light source for DVDs to irradiate laser beams when a DVD is set in the unit main body. When an optical disc is not set in the unit main body, the control board gives the light source for CDs and the light source for DVDs an instruction of laser beam irradiation inhibition. The control board does not permit the two light sources to irradiate laser beams simultaneously but may inhibit those light sources from irradiating laser beams. Thus, the control board is designed to give a pickup head a laser beams irradiation permission inhibition for each light source.

A monitoring photodetector for CDs and a monitoring photodetector for DVDs provided on a pickup head are individually connected to the control board. The control board instructs to the pickup head the light amount of a light source permitted to irradiate laser beams at that point in time based on the output detected at the monitoring photodetector corresponding to the light source permitted to irradiate laser beams at that point in time. To be more precise, when the light source for CDs are permitted to irradiate laser beams, the control board instructs to the pickup head to adjust the light amount of the light source for CDs to a predetermined light amount based on the output detected at the monitoring photodetector for CDs. When the light source for DVDs are permitted to irradiate laser beams, the control board instructs to the pickup head to adjust the light amount of the light source for DVDs to a predetermined light amount based on the output detected at the monitoring photodetector for DVDs.

The light amounts of the light source for CDs and the light source for DVDs are individually set on the control board. The light amount of each light source is individually set for data reading and recording.

### SUMMARY OF THE INVENTION

A related art optical disc apparatus supporting data reading/recording from/onto two types of optical discs is so arranged that two monitoring photodetectors provided on a pickup head not simultaneously required by a control board are individually connected to the control board. In this way, the control board individually receives detection outputs of two monitoring photodetectors so that it includes two monitoring circuits each designed to process the detection output of a monitoring photodetector. The two monitoring circuits each is designed to process the detection output of a monitoring photodetector do not simultaneously operate. From this, it is understood that at least one monitoring circuit is unnecessary because it is not operating. Introducing two of the monitoring circuits complicates the circuit pattern formed on a control board as well as increases the number of wires used to connect the pickup head and the control board thereby adding to the overall cost of the unit main body. The control board also has a tracking control circuit, a focusing control circuit, a decoding circuit and an encoding circuit formed thereon.

An object of the invention is to provide an optical disc apparatus supporting data reading/recording from/onto two types of optical discs that reduces the cost of the unit main body by reducing the number of wires connecting a control board and an pickup head as well as simplifying the circuit pattern on the control board.

The optical disc apparatus according to the invention includes the configuration described below.

According to a first aspect of the invention, there is provided an optical disc apparatus including: a pickup head including light sources for irradiating laser beams onto each of the two types of optical discs set in the unit main body and photodetectors for detecting the reflected light amount from the optical disc; and a control unit for permitting one light source of the pickup head to irradiate light source and inhibiting the other light source of the pickup head from irradiating light source in accordance with the type of an optical disc set in the unit main body, wherein the pickup head has a monitoring photodetector for detecting the light amount of laser beams irradiated from the each light source and a monitoring output selector for selectively inputting the output of the monitoring photodetector to the control unit; and when the control unit permits one light source to irradiate laser beams, the monitoring output selector inputs the output of the monitoring photodetector corresponding to the one light source to the control unit and, when the control unit does not permit one light source to irradiate laser beams, the monitoring output selector inputs the output of the monitoring photodetector corresponding to the other light source to the control unit.

In this configuration, the monitoring output selector provided on a pickup head inputs the output of the monitoring photodetector corresponding to a light source permitted to irradiate laser beams by the control unit to a control board. It is thus possible to share a wire for inputting the outputs of two monitoring photodetectors from a pickup head to a control unit. In other words, it is not necessary to provide a wire for inputting the output of each monitoring photodetector from a pickup head to a control unit. Also, on a control board constituting a control unit, it is not necessary to form a circuit pattern for processing the output of each monitoring photodetector. This simplifies the circuit pattern. Further, the pickup head selects the output of a monitoring photodetector to the control unit based on an instruction by the control unit to permit/inhibit one light source to irradiate/from irradiating laser beams. There is no need to provide a separate wire for sending such an instruction from the control unit to the monitoring output selector arranged on the pickup head.

It is thus possible to reduce the number of wires connecting a control unit and a pickup head as well as simplifies a circuit pattern on a control unit, thereby reducing the cost of the unit main body.

The two types of optical discs include a combination of a CD and a DVD, a combination of a CD and a BD, a combination of a DVD and a ED.

According to a second aspect of the invention, the control unit individually gives the pickup head a signal indicating permission or inhibition of laser beams to two light sources.

With this configuration, the control unit is capable of making an instruction to inhibit both light sources from irradiating laser beams. This prevents a light source from irradiating laser beams when an optical disc is not set in the unit main body.

According to a second aspect of the invention, the pickup head has a drive part common to two light sources and a drive selector for selecting a light source driven by the drive part and the drive selector selectively drives a light source permitted to irradiate light source by the control unit.

With this configuration, the drive part is common to two light sources, which further reduces the cost of the unit main body.

According to the invention, it is possible to reduce the number of wires connecting a control unit and a pickup head as well as simplifies a circuit pattern on a control unit, thereby reducing the cost of the unit main body.

### BRIEF DESCRIPTION OF THE DRAWINGS

These and other objects and advantages of this invention will become more fully apparent from the following detailed description taken with the accompanying drawings in which:

FIG. 1 shows the configuration of the main part of an optical disc apparatus according to an embodiment of the invention;

FIG. 2 shows the configuration of the pickup head of the optical disc apparatus according to this embodiment; and

FIG. 3 shows the configuration of the control board of the optical disc apparatus according to this embodiment.

### DETAILED DESCRIPTION OF THE PREFERRED EMBODIMENTS

An optical disc apparatus as an embodiment of the invention will be described.

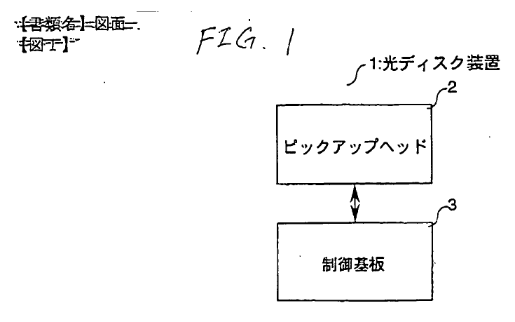

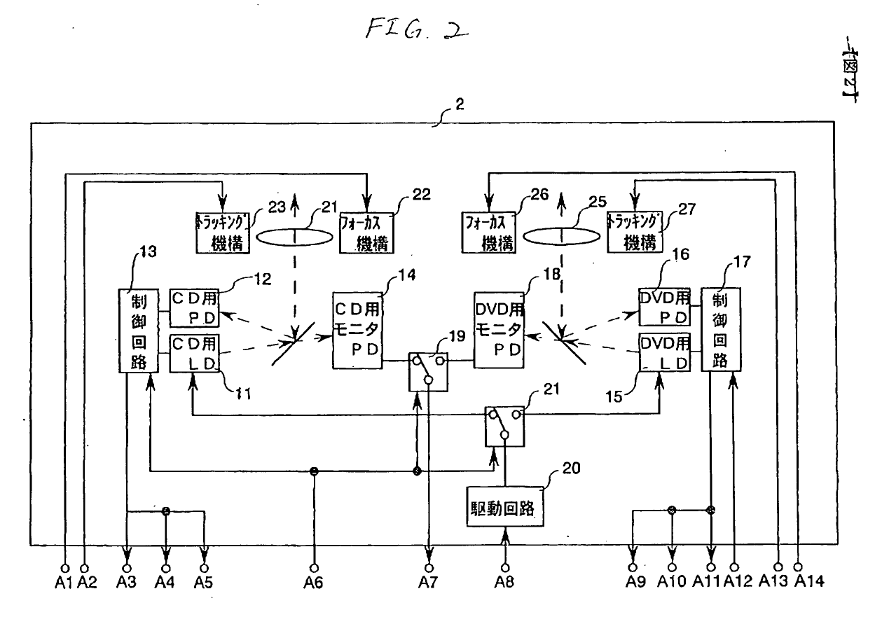

FIG. 1 shows the configuration of the main part of an optical disc apparatus according to an embodiment of the invention. An optical disc apparatus 1 according to this embodiment supports data reading/recording from/onto two types of optical discs, namely CDs and DVDs. The optical disc apparatus 1 according to this embodiment includes a pickup head 2 and a control board 3. The control board corresponds to a control unit according to the invention. FIG. 2 shows the configuration of the pickup head of the optical disc apparatus according to this embodiment. The pickup head 2 includes: an LD 11 for CDs for irradiating laser beams onto a CD; a PD 12 for CDs for detecting a reflected light of laser beams irradiated onto the CD; a control circuit 13 for controlling laser beam irradiation from the LD 11 for CDs and generating and outputting signals such as RF, FE and TE signals based on the reflected light detected by the PD 12 for CDs; a monitoring PD 14 for CDs for detecting laser beams irradiated from the LD 11 for CDs; an LD 15 for DVDs for irradiating laser beams onto a DVD; a PD 16 for DVDs for detecting a reflected light of laser beams irradiated onto the DVD; a control circuit 17 for controlling laser beam irradiation from the LD 15 for DVDs and generating and outputting signals such as RF, FE and TE signals based on the reflected light detected by the PD 16 for DVDs; a monitoring PD 18 for DVDs for detecting laser beams irradiated from the LD 15 for DVDs; a monitoring output selector 19 for selecting the output of one of the outputs of the monitoring PD 14 for CDs and the monitoring PD 18 for DVDs; a drive circuit 20 for driving the LD 11 for CDs and the LD 15 for DVDs; and a drive selector 21 for selecting the LD (LD 11 for CDs or LD 15 for DVDs) driven by the drive circuit 20. A numeral 21 shown in FIG. 2 represents an objective lens for CDs for condensing laser beams irradiated from the LD 11 for CDs onto the recording surface of a CD, 22 a focusing mechanism for driving the objective lens 21 in an approaching and separating direction (focusing direction) with respect to the recording surface of an optical disc, 23 a tracking mechanism for driving the objective lens 21 in the radial direction (tracking direction) of an optical disc, 25 an objective lens for DVDs for condensing laser beams irradiated from the LD 15 for DVDs onto the recording surface of a DVD, 26 a focusing mechanism for driving the objective lens 25 in an approaching and separating direction (focusing direction) with respect to the recording surface of an optical disc, and 27 a tracking mechanism for driving the objective lens 25 in the radial direction (tracking direction) of an optical disc.

A numeral 24 represents a beam splitter for splitting a laser beam emitted from the LD 11 for CDs and guiding one laser beam to a CD and the other beam to the monitoring PD 14 for CDs, 28 a beam splitter for splitting a laser beam emitted from the LD 15 for DVDs and guiding one laser beam to a DVD and the other beam to the monitoring PD 18 for DVDs. The LD 11 for CDs and the LD 15 for DVDs output laser beams having a different wavelength from each other.

To a terminal A1 shown FIG. 2 is input a focusing servo signal directed to the focusing mechanism 22 from the control board 3. To a terminal A2 is input a tracking servo signal directed to the tracking mechanism 23 from the control board 3. The focusing mechanism 22 drives the objective lens 21 in an approaching and separating direction with respect to a CD based on the input focusing servo signal. The tracking mechanism 23 drives the objective lens 21 in the radial direction of a CD based on the input tracking servo signal. To a terminal A3 is output a focusing error signal (FE signal) related to the objective lens 21. To a terminal A4 is output a tracking error signal (TE signal) related to the objective lens 21. To a terminal A5 is output an RF signal as a read signal from a CD. To a terminal A6 is input a signal permitting/inhibiting the LD 11 for CDs to irradiate/from irradiating laser beams. As shown in the figure, this signal is input to the control circuit 13, the monitoring output selector 19 and the drive selector 21. The control circuit 13 limits the emission of light from the LD 11 for CDs based on this signal. The monitoring output selector 19 switches the monitoring output on a terminal A7 (output of the monitoring PD 14 for CDs or monitoring PD 18 for DVDs). The drive selector 21 switches the LD (LD 11 for CDs or LD 15 for DVDs) driven by a drive signal input from a terminal A8. The drive signal input to the terminal A8 is input to the drive circuit 20, which drives the LD 11 for CDs or LD 15 for DVDs based on this signal.

To a terminal A14 is input a focusing servo signal directed to the focusing mechanism 26 from the control board 3. To a terminal A13 is input a tracking servo signal directed to the tracking mechanism 27 from the control board 3. The focusing mechanism 26 drives the objective lens 25 in an approaching and separating direction with respect to a DVD based on the input focusing servo signal. The tracking mechanism 27 drives the objective lens 25 in the radial direction of a DVD based on the input tracking servo signal. To a terminal A9 is output a focusing error signal related to the objective lens 25. To a terminal A10 is output a tracking error signal related to the objective lens 25. To a terminal A11 is output an RF signal as a read signal from a DVD. To a terminal A12 is input a signal permitting/inhibiting the LD 15 for DVDs to irradiate/from irradiating laser beams. This signal is input to the control circuit 17, and not the monitoring output selector 19 or the drive selector 21.

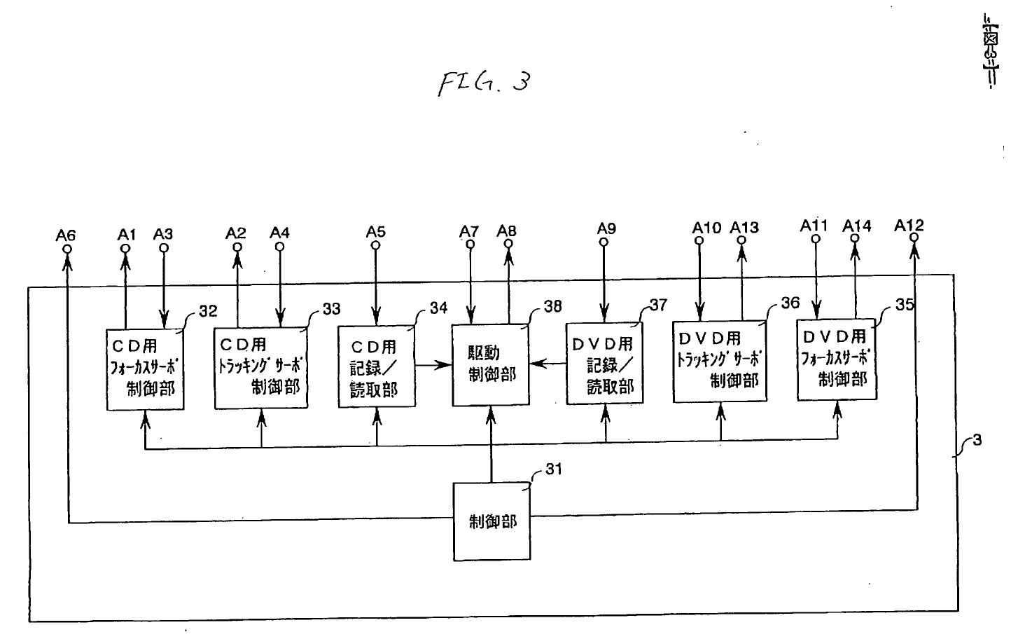

FIG. 3 shows the configuration of the control board of the optical disc apparatus according to this embodiment. The control board 3 includes: a controller 31 for controlling the operation on the control board 3; a focusing servo controller 32 for CDs for controlling the focusing mechanism 22 based on an FE signal output from the control board 13 on the CD side of the pickup head 2; a tracking servo controller 33 for CDs for controlling the tracking mechanism 23 based on a TE signal output from the control board 13 on the CD side of the pickup head 2; a recording/reading controller 34 for CDs for processing the RF signal output from the control circuit 13 on the CD side of the pickup head 2 and recording data to be recorded onto a CD; a focusing servo controller 35 for DVDs for controlling the focusing mechanism 26 based on the FE signal output from the control circuit 17 on the DVD side of the pickup head 2; a tracking servo controller 36 for DVDs for controlling the tracking mechanism 27 based on the TE signal output from the control circuit 17 on the DVD side of the pickup head 2; a recording/reading controller 37 for DVDs for processing the RF signal output from the control circuit 17 on the DVD side of the pickup head 2 and recording data to be recorded onto a DVD; and a drive controller 38 for controlling the LD 11 for CDs for CDs and the LD 15 for DVDs in the drive circuit 20.

The pickup head 2 and the control board 3 interconnect terminals having the same sign in FIG. 2 and FIG. 3.

The PD 12 for CDs and the PD 16 for DVDs each has a quadripartitioned photodetector similar to a known optical disc apparatus. The control circuit 13 uses a reflected light amount detected per partitioned area of the PD 12 for CDs to generate and output an RF signal, a TE signal and an RF signal. The control circuit 17 uses a reflected light amount detected per partitioned area of the PD 16 for DVDs to generate and output an RF signal, a TE signal and an RF signal. The FE signal, TE signal and RF signals are well known so that the corresponding description is omitted. The control circuit 13 makes control to inhibit the LD 11 for CDs from irradiating laser beams when an instruction to inhibit the LD 11 for CDs from irradiating laser beams is input from the control board 3. The control circuit 13 makes control to permit the LD 11 for CDs to irradiate laser beams when an instruction to permit the LD 11 for CDs to irradiate laser beams is input. The LD 11 for CDs is designed such that the LD 11 for CDs will not irradiate laser beams even in case a drive signal is input from the drive circuit 20 while the control circuit 13 is making control to inhibit the LD 11 for CDs from irradiating laser beams. The control circuit 17 makes control to inhibit the LD 15 for DVDs from irradiating laser beams when an instruction to inhibit the LD 15 for DVDs from irradiating laser beams is input from the control board 3. The control circuit 17 makes control to permit the LD 15 for DVDs to irradiate laser beams when an instruction to permit the LD 15 for DVDs to irradiate laser beams is input. The LD 15 for DVDs is designed such that the LD 15 for DVDs will not irradiate laser beams even in case a drive signal is input from the drive circuit 20 while the control circuit 17 is making control to inhibit the LD 15 for DVDs from irradiating laser beams.

When a signal to permit the LD 11 for CDs is input from the control board 3, the monitoring output selector 19 provides the output of the monitoring PD 14 for CDs to the terminal A7. Otherwise, that is, when a signal to permit the LD 15 for DVDs to irradiate laser beams is input or when a signal to inhibit the LD 11 for CDs and the LD 15 for DVDs from irradiating laser beams is input, the monitoring PD 18 for DVDs provides the output of the monitoring PD 18 for DVDs to the terminal A7. The monitoring output selector 19 is a general switch circuit. The drive selector 21 supplies a drive signal received from the drive circuit 20 to the LD 11 for CDs when a signal to permit the LD 11 for CDs to irradiate laser beams is input from the control board 3. Otherwise, that is, when a signal to permit the LD 15 for DVDs to irradiate laser beams is input or when a signal to inhibit the LD 11 for CDs and the LD 15 for DVDs from irradiating laser beams is input, the drive selector 21 supplies a drive signal received from the drive circuit 20 to the LD 15 for DVDs. The drive selector 21 is a general switch circuit.

The controller 31 on the control board 3 outputs to the terminal A6 a signal to permit the LD 11 for CDs to irradiate laser beams and outputs to the terminal A12 a signal to inhibit the LD 15 for DVDs from irradiating laser beams in case the optical disc set in the unit main body is a CD. The controller 31 outputs to the terminal A6 a signal to inhibit the LD 11 for CDs from irradiating laser beams and outputs to the terminal A12 a signal to permit the LD 15 for DVDs to irradiate laser beams in case the optical disc set in the unit main body is a DVD. The controller 31 outputs to the terminal A6 a signal to permit the LD 11 for CDs to irradiate laser beams and outputs to the terminal A12 a signal to inhibit the LD 15 for DVDs from irradiating laser beams in case the optical disc set in the unit main body is a CD. The controller 31 outputs to the terminals A6 and A12 a signal to inhibit the LD 11 for CDs and the LD 15 for DVDs from irradiating laser beams in case an optical disk is not set in the unit main body.

The focusing servo controller 32 for CDs generates a focusing servo signal based on an FE signal input from the control circuit 13 of the pickup head 2. The tracking servo controller 33 for CDs generates a tracking servo signal based on a TE signal input from the control circuit 13 of the pickup head 2. The focusing servo controller 35 for DVDs generates a focusing servo signal based on an FE signal input from the control circuit 17 of the pickup head 2. The tracking servo controller 36 for DVDs generates a tracking servo signal based on a TE signal input from the control circuit 17 of the pickup head 2. The focusing servo controller 32 for CDs and the tracking servo controller 33 for CDs operate while the controller 31 is outputting to the terminal A6 a signal to permit the LD 11 for CDs to irradiate laser beams and do not operate while the controller 31 is outputting to the terminal A6 a signal to inhibit the LD 11 for CDs from irradiating laser beams. The focusing servo controller 35 for DVDs and the tracking servo controller 36 for DVDs operate while the controller 31 is outputting to the terminal A12 a signal to permit the LD 15 for DVDs to irradiate laser beams and do not operate while the controller 31 is outputting to the terminal A12 a signal to inhibit the LD 15 for DVDs from irradiating laser beams.

The recording/reading controller 34 for CDs passes data to be recorded to the drive controller 38 in recording data onto a CD. The recording/reading controller 37 for DVDs passes data to be recorded to the drive controller 38 in recording data onto a DVD. The drive controller 38 supplies a drive signal to the drive circuit 20 based on the recorded data passed from the recording/reading controller 37 for DVDs. The recording/reading controller 34 for CDs is active while the controller 31 is outputting to the terminal A6 a signal to permit the LD 11 for CDs to irradiate laser beams. The recording/reading controller 34 for CDs is inactive while the controller 31 is outputting to the terminal A6 a signal to inhibit the LD 11 for CDs from irradiating laser beams. The recording/reading controller 37 for DVDs is active while the controller 31 is outputting to the terminal A12 a signal to permit the LD 15 for DVDs to irradiate laser beams. The recording/reading controller 37 for DVDs is inactive while the controller 31 is outputting to the terminal A12 a signal to inhibit the LD 15 for DVDs from irradiating laser beams.

The drive controller 38 generates a drive signal related to pulse control of laser beams irradiated from the LD 11 for CDs or the LD 15 for DVDs based on recorded data input from the recording/reading controller 34 for CDs or the recording/reading controller 37 for DVDs in recording of data onto an optical disc. The drive controller 38 also performs power control of laser beams irradiated from the LD 11 for CDs or the LD 15 for DVDs based on the output of the monitoring PD 14 for CDs or the monitoring PD 18 for DVDs input via the terminal A7. The drive controller stores four set powers; the set power of laser beams irradiated from the LD 11 for CDs in reading data recorded on a CD; the set power of laser beams irradiated from the LD 11 for CDs in recording data onto a CD; the set power of laser beams irradiated from the LD 15 for DVDs in reading data recorded on a DVD; and the set power of laser beams irradiated from the LD 15 for DVDs in recording data onto a DVD. The drive controller 38 controls a drive signal to be supplied to the drive circuit 20 based on these set powers.

Next, operation of the optical disc apparatus 1 according to this embodiment will be described. The controller 31 detects presence/absence of an optical disc set in the unit main body and the type of an optical disc (CD or DVD) in case one is set. While detecting that an optical disc is not set in the unit main body, the controller 31 outputs from the terminal A6 a signal to inhibit the LD 11 for CDs from irradiating laser beams and outputs from the terminal A12 a signal to inhibit the LD 15 for DVDs from irradiating laser beams. In other words, a signal to inhibit irradiation of laser beams is input to both the LD 11 for CDs and the LD 15 for DVDs. To the monitoring output selector 19 is input a signal to inhibit the LD 11 for CDs from irradiating laser beams so that the monitoring output selector 19 connects to the terminal A7 the output of the monitoring PD 18 for DVDs. To the drive selector 21 is input a signal to inhibit the LD 11 for CDs from irradiating laser beams so that the drive selector 21 supplies a drive signal to the LD 15 for DVDs.

On the control board 3, the focusing servo controller 32, the tracking servo controller 33 for CDs, the recording/reading controller 34 for CDs, the focusing servo controller 35 for DVDs, the tracking servo controller 36 for DVDs, the recording/reading controller 37 for DVDs, and the drive controller 38 are inactive. When an optical disc is not set in the unit main body, no parts are uselessly operating on the control board 3, which suppresses power consumption.

Even in case a drive signal generated due to noise in the drive circuit 20, is input to the LD 11 for CDs and LD 15 for DVDs by the control circuit 13, 17, the controller 31 inhibits the LD 11 for CDs and the LD 15 for DVDs from irradiating laser beams so that laser beams are not irradiated from the LD 11 for CDs or the LD 15 for DVDs.

Whether an optical disc is set in the unit main body is detected by presence/absence of a reflected light of laser beams of reading power irradiated from the LD 11 for CDs or LD 15 for DVDs at power on. In case it is detected that an optical disc is set in the unit main body, the type of the optical disc is determined by reading the data recorded in the information area of the optical disc.

Next, operation of the optical disc apparatus 1 assumed when a CD is set in the unit main body will be described. The controller 31 is outputting from the terminal A6 a signal to permit the LD 11 for CDs to irradiate laser beams and outputting from the terminal A12 a signal to inhibit the LD 15 for DVDs from irradiating laser beams while detecting that a CD is set in the unit main body. To the monitoring output selector 19 is input a signal to permit the LD 11 for CDs to irradiate laser beams so that the monitoring output selector 19 supplies the output of the monitoring PD 14 for CDs to the terminal A7. To the drive selector 21 is input a signal to permit the LD 11 for CDs to irradiate laser beams so that the drive selector 21 supplies a drive signal to the LD 15 for DVDs.

On the control board 3, the focusing servo controller 32, the tracking servo controller 33 for CDs, the recording/reading controller 34 for CDs, and the drive controller 38 are active. The focusing servo controller 35 for DVDs, the tracking servo controller 36 for DVDs, and the recording/reading controller 37 for DVDs are inactive. When a CD is set in the unit main body, in other words, when a DVD is not set in the unit main body, the parts on the control board 3 that perform processing related to DVDs are inactive, which suppresses power consumption.

Based on a focus error signal input to the terminal A3 by the control circuit 13, the focusing servo controller 32 for CDs generates a focusing servo signal and supplies the signal to the focusing mechanism 22 via the terminal A1. The focusing mechanism 22 moves the objective lens 21 in an approaching and separating direction with respect to a CD based on the supplied focusing servo signal. This control process related to focusing is a well-known control to focus laser beams emitted from the LD 11 for CDs onto the recording surface of a CD. The tracking servo controller 33 for CDs generates a tracking servo signal based on a tracking error signal input to the terminal A4 by the control circuit 13 and supplies the tracking servo signal to the tracking mechanism 23 via the terminal A2. The tracking mechanism 23 moves the objective lens 21 in the radial direction of a CD based on the supplied tracking servo signal. This control process related to tracking is a well-known control to focus laser beams emitted from the LD 11 for CDs onto the center of a recording track formed on a CD.

The drive controller 38 generates a drive signal to supply to the LD 11 for CDs based on the output of the monitoring PD 14 for CDs input via the terminal A7. To be more precise, the drive controller 38 generates a drive signal to supply to the LD 11 for CDs so that the power of laser beams emitted from the LD 11 for CDs will reach a preset magnitude. In reading, the drive controller 38 generates a drive signal that causes continuous transmission of laser beams emitted from the LD 11 for CDs in reading and causes pulse transmission of laser beams emitted from the LD 11 for CDs in accordance with the data to record in recording. The drive signal generated by the drive controller 38 is input to the drive circuit 20. The drive circuit 20 drives the LD 11 for CDs based on the input drive signal and controls the power of laser beams emitted from the LD 11 for CDs. In this practice, the drive selector 21 is switched to supply the output of the drive circuit 20 to the LD 11 for CDs. A signal to inhibit the LD 15 for DVDs from irradiating laser beams is input to the control circuit 17. Thus, it is possible to prevent damage to a CD set in the unit main body caused by irradiation of laser beams from the LD 15 for DVDs.

Next, operation of the optical disc apparatus 1 assumed when a DVD is set in the unit main body will be described. The controller 31 is outputting from the terminal A6 a signal to inhibit the LD 11 for CDs to irradiate laser beams and outputting from the terminal A12 a signal to permit the LD 15 for DVDs to irradiate laser beams while detecting that a DVD is set in the unit main body. To the monitoring output selector 19 is input a signal to inhibit the LD 11 for CDs from irradiating laser beams so that the monitoring output selector 19 supplies the output of the monitoring PD 18 for DVDs to the terminal A7. To the drive selector 21 is input a signal to inhibit the LD 11 for CDs from irradiating laser beams so that the drive selector 21 supplies a drive signal to the LD 11 for CDs.

On the control board 3, the focusing servo controller 32, the tracking servo controller 33 for CDs, and the recording/reading controller 34 for CDs are inactive. The focusing servo controller 35 for DVDs, the tracking servo controller 36 for DVDs, the recording/reading controller 37 for DVDs, and the drive controller 38 are active. When a DVD is set in the unit main body, in other words, when a CD is not set in the unit main body, the parts on the control board 3 that perform processing related to CDs are inactive, which suppresses power consumption.

Based on a focus error signal input to the terminal A11 by the control circuit 13, the focusing servo controller 35 for DVDs generates a focusing servo signal and supplies the signal to the focusing mechanism 26 via the terminal A14. The focusing mechanism 26 moves the objective lens 25 in an approaching and separating direction with respect to a DVD based on the supplied focusing servo signal. This control process related to focusing is a well-known control to focus laser beams emitted from the LD 15 for DVDs onto the recording surface of a DVD. The tracking servo controller 36 for DVDs generates a tracking servo signal based on a tracking error signal input to the terminal A10 by the control circuit 13 and supplies the tracking servo signal to the tracking mechanism 27 via the terminal A13. The tracking mechanism 27 moves the objective lens 25 in the radial direction of a DVD based on the supplied tracking servo signal. This control process related to tracking is a well-known control to focus laser beams emitted from the LD 15 for DVDs onto the center of a recording track formed on a DVD.

The drive controller 38 generates a drive signal to supply to the LD 15 for DVDs based on the output of the monitoring PD 18 for DVDs input via the terminal A7. To be more precise, the drive controller 38 generates a drive signal to supply to the LD 15 for DVDs so that the power of laser beams emitted from the LD 15 for DVDs will reach a preset magnitude. In reading, the drive controller 38 generates a drive signal that causes continuous transmission of laser beams emitted from the LD 15 for DVDs in reading and causes pulse transmission of laser beams emitted from the LD 15 for DVDs in accordance with the data to record in recording. The drive signal generated by the drive controller 38 is input to the drive circuit 20. The drive circuit 20 drives the LD 15 for DVDs based on the input drive signal and controls the power of laser beams emitted from the LD 15 for DVDs. In this practice, the drive selector 21 is switched to supply the output of the drive circuit 20 to the LD 15 for DVDs. A signal to inhibit the LD 11 for CDs from irradiating laser beams is input to the control circuit 13. Thus, it is possible to prevent damage to a DVD set in the unit main body caused by irradiation of laser beams from the LD 11 for CDs.

In this way, the optical disc apparatus 1 according to this embodiment provides a monitoring output selector 19 on the pickup head 2. A signal to permit/inhibit the LD 11 for CDs to irradiate laser beams/from irradiating laser beams is split inside the pickup head to provide split signals to the LD 11 for CDs, the monitoring output selector 19 and the drive selector 21. This configuration reduces the number of wires connecting the pickup head and the control board 3. The output of the monitoring PD 14 for CDs and that of the monitoring PD 18 for DVDs are processed by a common circuit on the control board 3, which simplifies tie circuit configuration. This sufficiently reduces the cost of the optical disc apparatus main body 1.

A signal to permit/inhibit the LD 11 for CDs/LD 15 for DVDs to irradiate/from irradiating laser beams is individually supplied. This prevents a case where laser beams are irradiated from the LD 11 for CDs due to noise in the drive circuit 20. A drive part common to the LD 11 for CDs and the LD 15 for DVDs is provided, which further reduces the cost.

While the invention has been described using as an example an optical disc apparatus supporting data reading/recording from/onto a CD or a DVD, the invention is also applicable to an optical disc apparatus supporting data reading/recording from/to two types of separate optical discs, such as a CD and a BD as well as a DVD and a BD.

FIG. 1

1: OPTICAL DISK UNIT
2: PICKUP HEAD
3: CONTROL BOARD
   FIG. 2
11: LD FOR CDS
12: PD FOR CDS
13: CONTROL CIRCUIT
14: MONITORING PD FOR CDS
15: LD FOR DVDS
16: PD FOR DVDS
17: CONTROL CIRCUIT
18: MONITORING PD FOR DVDS
20: DRIVE CIRCUIT
22, 26: FOCUSING MECHANISM
23, 27: TRACKING MECHANISM
   FIG. 3
31: CONTROLLER
32: FOCUSING SERVO CONTROLLER FOR CDS
33: TRACKING SERVO CONTROLLER FOR CDS
34: RECORDING/READING CONTROLLER FOR CDS
35: FOCUSING SERVO CONTROLLER FOR DVDS
36: TRACKING SERVO CONTROLLER FOR DVDS
37: RECORDING/READING CONTROLLER FOR DVDS
38: DRIVE CONTROLLER

What is claimed is:

1. An optical disc apparatus comprising:
a pickup head including light sources for irradiating laser beams onto each of the two types of optical discs set in the unit main body and photodetectors for detecting the reflected light amount from the optical disc; and
a control unit for permitting one light source of the pickup head to irradiate light source and inhibiting the other light source of the pickup head from irradiating light source in accordance with the type of an optical disc set in the unit main body, wherein:
the pickup head has a monitoring photodetector for detecting the light amount of laser beams irradiated from the each light source and a monitoring output selector for selectively inputting the output of the monitoring photodetector to the control unit;
one of the two light sources is for CDs and the other is for DVDs;
when the control unit permits one light source to irradiate laser beams, the monitoring output selector inputs the output of the monitoring photodetector corresponding to the one light source to the control unit and, when the control unit does not permit one light source to irradiate laser beams, the monitoring output selector inputs the output of the monitoring photodetector corresponding to the other light source to the control unit;
the control unit individually gives the pickup head a signal indicating permission or inhibition of laser beams to two light sources; and
the pickup head has a drive part common to two light sources and a drive selector for selecting a light source driven by the drive part and the drive selector selectively drives a light source permitted to irradiate light source by the control unit.

2. An optical disc apparatus comprising:
a pickup head including light sources for irradiating laser beams onto each of the two types of optical discs set in the unit main body and photodetectors for detecting the reflected light amount from the optical disc; and
a control unit for permitting one light source of the pickup head to irradiate light source and inhibiting the other light source of the pickup head from irradiating light source in accordance with the type of an optical disc set in the unit main body, wherein
the pickup head has a monitoring photodetector for detecting the light amount of laser beams irradiated from the each light source and a monitoring output selector for selectively inputting the output of the monitoring photodetector to the control unit; and
when the control unit permits one light source to irradiate laser beams, the monitoring output selector inputs the output of the monitoring photodetector corresponding to the one light source to the control unit and, when the control unit does not permit one light source to irradiate laser beams, the monitoring output selector inputs the output of the monitoring photodetector corresponding to the other light source to the control unit.

3. The optical disc apparatus according to claim 2, wherein
the control unit individually gives the pickup head a signal indicating permission or inhibition of laser beams to two light sources.

4. The optical disc apparatus according to claim 2, wherein
the pickup head has a drive part common to two light sources and a drive selector for selecting a light source driven by the drive part and the drive selector selectively drives a light source permitted to irradiate light source by the control unit.

5. The optical disc apparatus according to claim 2, wherein
one of the two light sources of the pickup head is for CDs and the other is for DVDs.
